(19) United States
(12) Patent Application Publication
(10) Pub. No.: US 2017/0029059 A1
(43) Pub. Date: Feb. 2, 2017

(54) METHOD AND DEVICE FOR CONTROLLING BALANCING TRANSPORTER

(71) Applicant: Xiaomi Inc., Beijing (CN)

(72) Inventors: Huayijun LIU, Beijing (CN); Mingyong TANG, Beijing (CN); Tao CHEN, Beijing (CN)

(73) Assignee: Xiaomi Inc.

(21) Appl. No.: 15/193,581

(22) Filed: Jun. 27, 2016

(30) Foreign Application Priority Data
Jul. 29, 2015 (CN) 201510455016.6

(51) Int. Cl. B62K 3/00; B62D 37/00

(52) U.S. Cl. CPC B62K 3/007; B62D 37/00

(57) ABSTRACT

The present disclosure relates to a method and device for controlling a balancing transporter. The method includes: acquiring distances between the balancing transporter and one or more obstacles around the balancing transporter; determining a number of acquired distances that are shorter than a predetermined distance; and when the number of the acquired distances shorter than the predetermined distance reaches a predetermined number, determining that a stationary mode of the balancing transporter needs to be activated, wherein the balancing transporter automatically maintains balance in the stationary mode.

### CROSS-REFERENCE TO RELATED APPLICATIONS

This application is based upon and claims priority to Chinese Patent Application No. 201510455016.6, filed Jul. 29, 2015, the entire contents of which are incorporated herein by reference.

### TECHNICAL FIELD

The present disclosure generally relates to the technical field of a balancing transporter and, more particularly, to a method and device for controlling a balancing transporter.

### BACKGROUND

Nowadays, more and more balancing transporters have entered people's daily life. A rider of a balancing transporter usually needs to waggle his or her body to keep the balancing transporter in a balanced state. However, this control method is difficult to use when the balancing transporter is confined in a small space.

### SUMMARY

According to a first aspect of the present disclosure, there is provided a method for controlling a balancing transporter, comprising: acquiring distances between the balancing transporter and one or more obstacles around the balancing transporter; determining a number of acquired distances that are shorter than a predetermined distance; and when the number of the acquired distances shorter than the predetermined distance reaches a predetermined number, determining that a stationary mode of the balancing transporter needs to be activated, wherein the balancing transporter automatically maintains balance in the stationary mode.

According to a second aspect of the present disclosure, there is provided a device for controlling a balancing transporter, comprising: a processor; and a memory for storing instructions executable by the processor; wherein the processor is configured to: acquire distances between the balancing transporter and one or more obstacles around the balancing transporter; determine a number of acquired distances that are shorter than a predetermined distance; and when the number of the acquired distances shorter than the predetermined distance reaches a predetermined number, determine that a stationary mode of the balancing transporter needs to be activated, wherein the balancing transporter automatically maintains balance in the stationary mode.

According to a third aspect of the present disclosure, there is provided a non-transitory computer-readable storage medium storing instructions that, when executed by a processor of a device, cause the device to perform a method for controlling a balancing transporter, the method comprising: acquiring distances between the balancing transporter and one or more obstacles around the balancing transporter; determining a number of acquired distances that are shorter than a predetermined distance; and when the number of the acquired distances shorter than the predetermined distance reaches a predetermined number, determining that a stationary mode of the balancing transporter needs to be activated, wherein the balancing transporter automatically maintains balance in the stationary mode.

It is to be understood that both the forgoing general description and the following detailed description are exemplary only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for controlling a balancing transporter, according to an exemplary embodiment.

FIG. 2A is a flowchart of a method for controlling a balancing transporter, according to an exemplary embodiment.

FIG. 2B is a schematic diagram illustrating a prompt generated by a balancing transporter, according to an exemplary embodiment.

FIG. 2C is a flowchart of a method for controlling a balancing transporter, according to an exemplary embodiment.

FIG. 2D is a schematic diagram illustrating an implementation of a method for controlling a balancing transporter, according to an exemplary embodiment.

FIG. 3 is a block diagram of a device for controlling a balancing transporter, according to an exemplary embodiment.

FIG. 4 is a block diagram of a device for controlling a balancing transporter, according to an exemplary embodiment.

FIG. 5 is a block diagram of a device for controlling a balancing transporter, according to an exemplary embodiment.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the present disclosure. Instead, they are merely examples of devices and methods consistent with aspects related to the invention as recited in the appended claims.

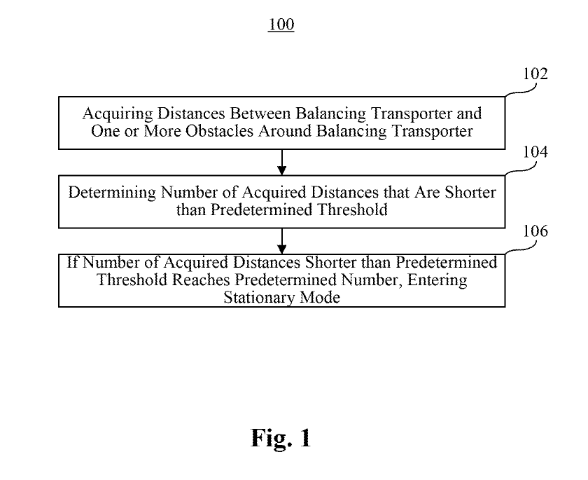

FIG. 1 is a flowchart of a method 100 for controlling a balancing transporter, according to an exemplary embodiment. For example, the method 100 is performed in the balancing transporter. As shown in FIG. 1, the method 100 includes the following steps.

In step 102, the balancing transporter acquires distances between the balancing transporter and one or more obstacles around the balancing transporter.

In step 104, the balancing transporter determines the number of acquired distances that are shorter than a predetermined threshold.

In step 106, if the number of acquired distances shorter than the predetermined threshold reaches a predetermined number, the balancing transporter enters a stationary mode. The balancing transporter automatically keeps balance and/or stays motionless in the stationary mode.

According to the method 100, the balancing transporter first acquires one or more distances, each of which is between the balancing transporter and an obstacle around the balancing transporter. If the number of distances shorter than a predetermined threshold reaches a predetermined number, the balancing transporter automatically enters a stationary mode. The balancing transporter automatically maintains balance in the stationary mode. Accordingly, the balancing transporter can automatically maintain balance after entering a small confined space. Therefore, the method 100 solves a problem that it is difficult, in the small confined space, for a rider to waggle his or her body to keep the balancing transporter in a balanced state.

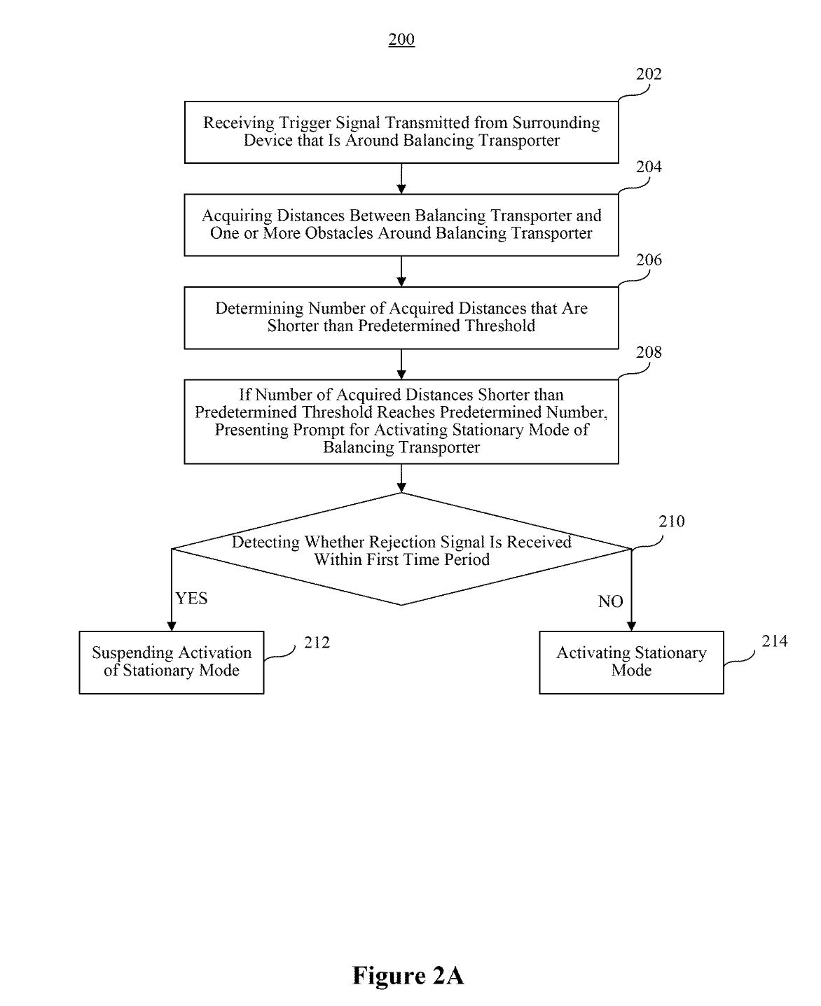

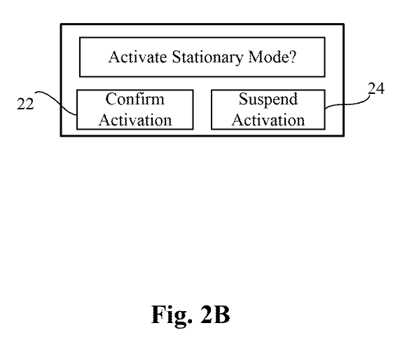

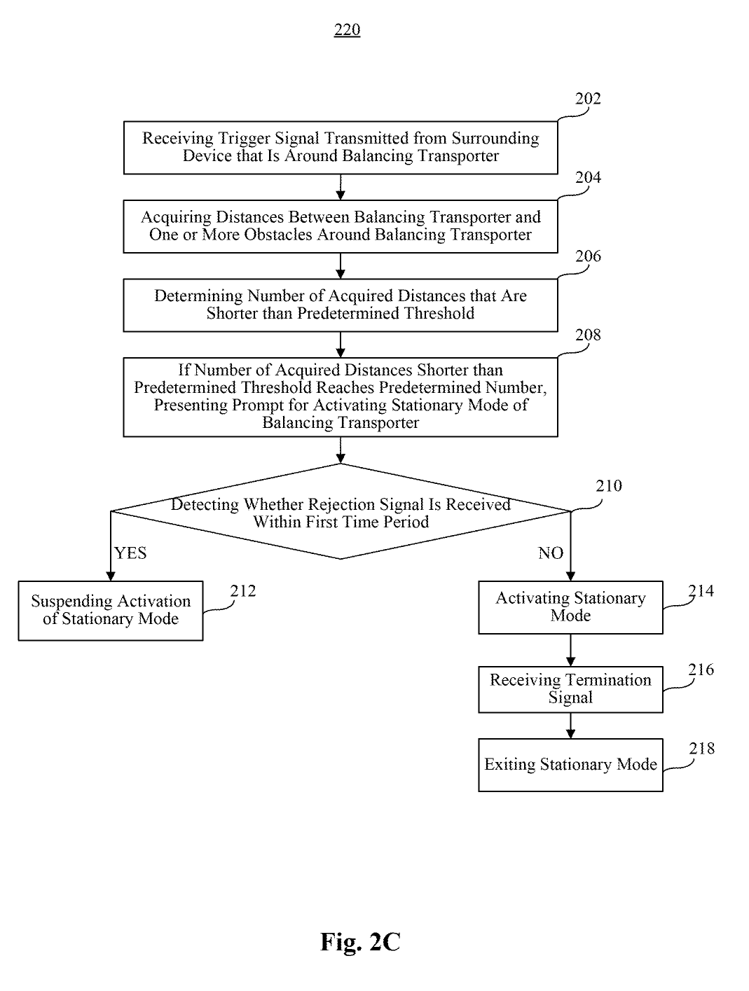

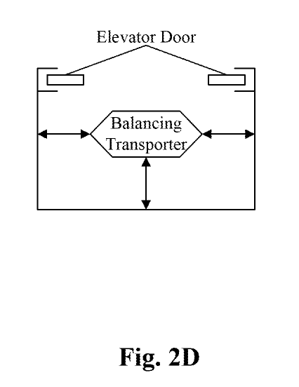

FIG. 2A is a flowchart of a method 200 for controlling a balancing transporter, according to an exemplary embodiment. For example, the method 200 is performed in the balancing transporter. As shown in FIG. 2A, the method 200 includes the following steps.

In step 202, the balancing transporter receives a trigger signal transmitted from a surrounding device that is around the balancing transporter. The trigger signal is transmitted from the surrounding device to the balancing transporter after the balancing transporter enters a predetermined area. The predetermined area is a communication area within which the surrounding device and the balancing transporter can communicate with each other.

The balancing transporter and the surrounding device are pre-configured to communicate according to a communication protocol. This way, as soon as the balancing transporter enters the communication area, the balancing transporter can receive the trigger signal from the surrounding device. In some embodiments, the surrounding device is a device capable of forming a closed space for carrying the balancing transporter and its user. The size of this closed space is smaller than the size of the predetermined area. For instance, the surrounding device may be an elevator, a subway car, or a railroad car.

The balancing transporter's receiving of the trigger signal transmitted from the surrounding device may include: the balancing transporter sending a detection signal, receiving a feedback signal from the surrounding device, and recognizing the feedback signal as a trigger signal. Alternatively, the balancing transporter's receiving of the trigger signal transmitted from the surrounding device may include: the balancing transporter receiving a trigger signal sent directly by the surrounding device.

For example, the surrounding device is an elevator. When a user and the balancing transporter enter the elevator or any predetermined area where the balancing transporter can communicate with the elevator, the balancing transporter receives a trigger signal transmitted from the elevator.

In step 204, the balancing transporter acquires distances between the balancing transporter and one or more obstacles around the balancing transporter.

The balancing transporter may acquire the distances at any time, or only after receiving the trigger signal. The present disclosure does not limit the timing of acquiring the distances.

For example, the balancing transporter may include an infrared detector used for measuring the distances from the balancing transporter to obstacles in four directions, i.e., the front, back, left, and right of the balancing transporter. In exemplary embodiments, the balancing transporter may use any suitable devices and methods to measure the distances, which are not limited by the present disclosure.

In step 206, the balancing transporter determines the number of the acquired distances that are shorter than a predetermined threshold.

In step 208, if the number of the acquired distances shorter than the predetermined threshold reaches a predetermined number, the balancing transporter presents a prompt for activating a stationary mode of the balancing transporter.

The balancing transporter may present the prompt through a user interface of the balancing transporter, such as a display screen and/or a speaker mounted on a handle of the balancing transporter. FIG. 2B is a schematic diagram illustrating a prompt generated by a balancing transporter, according to an exemplary embodiment. Referring to FIG. 2B, the balancing transporter displays “Activate Stationary Mode?” on a display screen. The balancing transporter may also generate a voice message or a sound to present the prompt. For example, the balancing transporter generates a beeping sound while displaying the prompt as shown in FIG. 2B.

In some embodiments, the predetermined number of the distances shorter than the predetermined threshold is an integer larger than or equal to 3. For example, if the balancing transporter detects that the distances from the balancing transporter to obstacles in at least three directions are shorter than the predetermined threshold, the balancing transporter determines that it enters a confined space, such as an elevator. The balancing transporter then presents the prompt.

In step 210, the balancing transports detects whether a rejection signal is received within a first time period. The rejection signal is used to instruct the balancing transporter not to activate the stationary mode.

After presenting the prompt, the balancing transporter starts a timer and monitors the operations of the user. The balancing transporter determines whether any rejection signal is generated by a user operation. If the balancing transporter receives the rejection signal within the first time period, step 212 is performed. Otherwise, step 214 is performed.

With continued reference to FIG. 2B, in addition to displaying the prompt “Activate Stationary Mode?,” the balancing transporter also displays a first option 22, i.e., “Confirm Activation,” and a second option 24, i.e., “Suspend Activation.” If the user wants the balancing transporter to enter the stationary mode, the user selects the option 22. If the user does not want the balancing transporter to enter the stationary mode, the user selects the option 24. The user's selection generates a signal receivable by the balancing transporter. The signal instructs the balancing transporter whether to activate the stationary mode.

In step 212, if the rejection signal is received within the first time period, the balancing transporter suspends the activation of the stationary mode.

If the rejection signal is received within the first time period, this indicates that the user does not want the balancing transporter to enter the stationary mode. Accordingly, the balancing transporter suspends the activation of the stationary mode. In one embodiment, the balancing transporter may start a timer and keep the activation suspended for a second time period. For example, after the second time period elapses, the balancing transporter may perform steps 208 and 210 again.

In step 214, if no rejection signal is received within the first time period, the balancing transporter activates the stationary mode.

In one embodiment, if the balancing transporter receives a confirmation signal for confirming the activation of the stationary mode, the balancing transporter activates the stationary mode immediately. However, if no signal is received within the first time period, the balancing transporter activates the stationary mode at the end of the first time period. In the stationary mode, the balancing transporter automatically keeps balance.

The balancing transporter may activate the stationary mode in the following two ways. In the first way, the balancing transporter activates an auto-balancing system of the balancing transporter to maintain balance automatically. In the second way, the balancing transporter activates a braking function of the balancing transporter. The braking function restricts the movement of the balancing transporter and thus keeps the balancing transporter in a balanced state.

In exemplary embodiments, step 202 is an optional step. Moreover, the above-described order of the steps is for illustrative purpose only. For example, if step 202 is included in the method 100, step 202 may be performed at any time before step 214, not necessarily as the first step of the method 200.

In exemplary embodiments, steps 208-212 are also optional. For example, when determining that the number of distances shorter than the predetermined threshold reaches the predetermined number (step 206), the balancing transporter may activate the stationary mode directly, i.e., skipping steps 208-214 and directly performing step 214.

FIG. 2C is a flowchart of a method 220 for controlling a balancing transporter, according to another embodiment. Referring to FIG. 2C, in addition to the above-described steps 202-214 (FIG. 2A), the method 220 may further include the following steps 216 and 218.

In step 216, the balancing transporter receives a termination signal for terminating the stationary mode.

After the balancing transporter activates the stationary mode, if the user wants to move the balancing transporter again, the user may operate the balancing transporter to exit the stationary mode. Such a user operation generates a termination signal receivable by the balancing transporter.

In exemplary embodiments, the balancing transporter may receive the termination signal in any suitable way. For example, the balancing transporter may provide a button used for turning off the stationary mode. When the user wants to terminate the stationary mode, the user presses this button to generate a termination signal receivable by the balancing transporter.

In step 218, in response to receiving the termination signal, the balancing transporter exits the stationary mode.

After receiving the termination signal, the balancing transporter exits the stationary mode. Subsequently, the user resumes the normal control of the balancing transporter, such as waggling his or her body to maintain the balance of the balancing transporter.

FIG. 2D is a schematic diagram illustrating an implementation of the method 200 or 220, according to an exemplary embodiment. Referring to FIG. 2D, after receiving a trigger signal transmitted from an elevator, a balancing transporter uses an infrared detector to measure the distances between the balancing transporter and one or more obstacles around the balancing transporter. When the balancing transporter determines that the number of distances shorter than a predetermined threshold reaches 3, such as the distances from the balancing transporter to obstacles on the left, right, and back of the balancing transporter are shorter than the predetermined threshold, the balancing transporter determines that the user and the balancing transporter have entered the elevator. The balancing transporter then activates the stationary mode to automatically maintain balance. In this way, the balancing transporter activates the stationary mode before the elevator doors close, and no longer requires the user to waggle his or her body to keep the balancing transporter balanced. Therefore, the user experience is improved. In one embodiment, before activating the stationary mode, the balancing transporter displays, on a display screen mounted on a handle of the balancing transporter, a prompt for activating the stationary mode. If no rejection signal is received within a predetermined time period, the balancing transporter activates the stationary mode. Conversely, if a rejection signal is received within the predefined time period, this indicates that the user is probably waiting outside the elevator and does not want to activate the stationary mode. Accordingly, the balancing transporter temporarily does not activate the stationary mode.

According to the method 200 or 220, the balancing transporter activates the stationary mode after receiving the trigger signal from a surrounding device. This way, the method 200 or 220 avoids erroneous activation of the stationary mode and minimizes unnecessary disturbance to the user's normal use of the balancing transporter. Moreover, the balancing transporter may acquire the distances between the balancing transporter and the surrounding obstacles only after the balancing transporter receives the trigger signal, rather than in real time. Therefore, the processing complexity of acquiring the distances is reduced for the balancing transporter.

Moreover, the method 200 or 220 activates the stationary mode once the number of the acquired distances shorter than the predetermined threshold reaches a predetermined number, instead of when all the acquired distances are shorter than the predetermined threshold. Therefore, the method 200 or 220 increases the promptness of activating the stationary mode of the balancing transporter.

Furthermore, the method 200 or 220 presents a prompt before the balancing transporter activates the stationary mode, and, based on the user selection, either temporarily suspends the activation of the stationary mode or immediately activates the stationary mode. This way, the method 200 or 220 can better satisfy the user's needs and improve the user experience.

In addition, according to the method 220, the user can terminate the stationary mode when the user wants to take back control of the balancing transporter. Therefore, the method 220 makes it convenient to use the balancing transporter.

The following embodiments are devices that may be used to perform the above-described methods. Any undisclosed details of the devices of the following embodiments may be found by referring to the above-described methods.

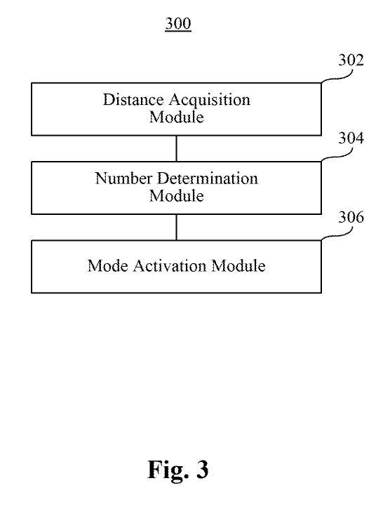

FIG. 3 is a block diagram of a device 300 for controlling a balancing transporter, according to an exemplary embodiment. For example, the device 300 may be implemented as part or whole of the balancing transporter. As shown in FIG. 3, this device 300 includes at least a distance acquisition module 302, a number determination module 304, and a mode activation module 306.

The distance acquisition module 302 is configured to acquire distances between the balancing transporter and one or more obstacles around the balancing transporter.

The number determination module 304 is configured to determine the number of acquired distances that are shorter than a predetermined threshold.

The mode activation module 306 is configured to activate a stationary mode of the balancing transporter if the number determined by the number determination module 304 reaches a predetermined number. The balancing transporter automatically maintains balance in the stationary mode.

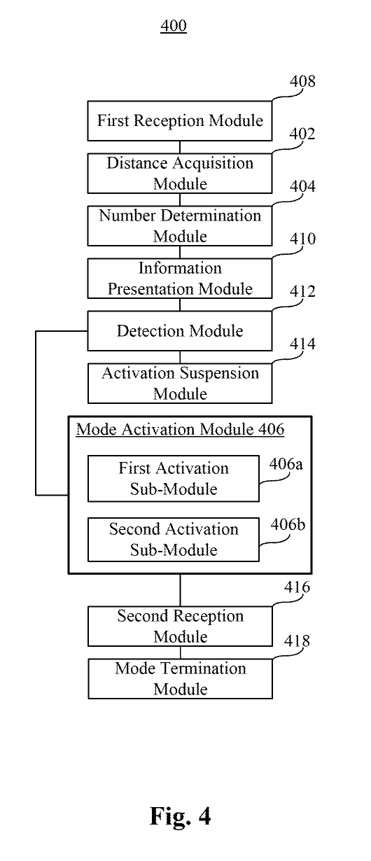

FIG. 4 is a block diagram of a device 400 for controlling a balancing transporter, according to an exemplary embodiment. For example, the device 400 may be implemented as part or whole of the balancing transporter. As shown in FIG. 4, the device 400 includes at least a distance acquisition module 402, a number determination module 404, and a mode activation module 406, similar to the distance acquisition module 302, the number determination module 304, and the mode activation module 306 (FIG. 3).

In some embodiments, the device 400 further includes a first reception module 408 configured to receive a trigger signal transmitted from a surrounding device before the mode activation module 406 activates the stationary mode of the balancing transporter. The surrounding device transmits the trigger signal to the balancing transporter after the balancing transporter enters a predetermined area. The predetermined area is a communication area within which the surrounding device and the balancing transporter can communicate with each other.

In some embodiments, the device 400 further includes an information presentation module 410, a detection module 412, and an activation suspension module 414. The presentation module 410 is configured to present a prompt for activating the stationary mode. The detection module 412 is configured to detect whether a rejection signal is received within a predetermined time period. The rejection signal is used to instruct the balancing transporter temporarily not to activate the stationary mode. The activation suspension module 414 is configured to suspend the activation of the stationary mode if the detection module 412 detects that the rejection signal is received. The mode activation module 406 is further configured to activate the stationary mode if the detection module 412 detects that no rejection signal is received within the predetermined time period.

In some embodiments, the mode activation module 406 further includes a first activation sub-module 406a and/or a second activation sub-module 406b. The first activation sub-module 406a is configured to activate an auto-balancing system of the balancing transporter. The second activating sub-module 406b is configured to activate a braking function of the balancing transporter.

In some embodiments, the device 400 further includes a second reception module 416 and a mode termination module 418. The second reception module 416 is configured to receive a termination signal. The mode termination module 418 is configured to terminate the stationary mode of the balancing transporter after the second reception module 416 receives the termination signal.

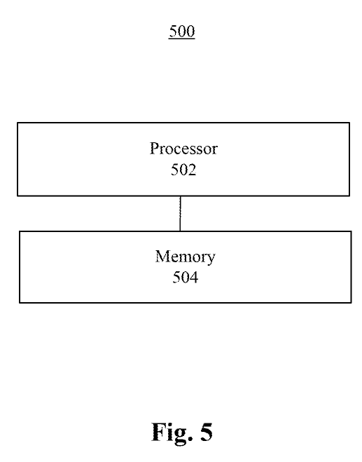

FIG. 5 is a block diagram of a device 500 for controlling a balancing transporter, according to an exemplary embodiment. For example, the device 500 may be used in the balancing transporter. Referring to FIG. 5, the device 500 includes a processor 502 and a memory 504 for storing instructions executable by the processor 502. The processor 502 is configured to perform the above described methods for controlling the balancing transporter according to the stored instructions.

With respect to the devices described in the above embodiments, the specific ways for performing operations by individual modules therein have been described in detail in the embodiments regarding the relevant methods, which will not be repeated here.

It will be appreciated that the inventive concept is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for controlling a balancing transporter, comprising:
acquiring distances between the balancing transporter and one or more obstacles around the balancing transporter;
determining a number of acquired distances that are shorter than a predetermined distance; and
when the number of the acquired distances shorter than the predetermined distance reaches a predetermined number, determining that a stationary mode of the balancing transporter needs to be activated, wherein the balancing transporter automatically maintains balance in the stationary mode.

2. The method of claim 1, further comprising:
in response to the determination that the stationary mode needs to be activated, activating the stationary mode of the balancing transporter.

3. The method of claim 1, further comprising:
prior to activating the stationary mode of the balancing transporter, receiving a trigger signal that is transmitted from a surrounding device after the balancing transporter enters a predetermined area, the predetermined area being a communication area within which the surrounding device and the balancing transporter communicate with each other.

4. The method of claim 1, further comprising:
presenting a prompt for activating the stationary mode of the balancing transporter;
detecting whether a rejection signal is received within a predetermined time period, the rejection signal being configured to instruct the balancing transporter temporarily not to activate the stationary mode;
if the rejection signal is received within the predetermined time period, suspending the activation of the stationary mode; and
if no rejection signal is received within the predetermined time period, activating the stationary mode.

5. The method of claim 1, wherein the activating of the stationary mode of the balancing transporter includes at least one of:
activating an auto-balancing system of the balancing transporter; or
activating a braking function of the balancing transporter.

6. The method of claim 2, further comprising:
receiving a termination signal; and
in response to the termination signal, terminating the stationary mode of the balancing transporter.

7. The method of claim 3, further comprising:
if the stationary mode is activated, receiving a termination signal; and
in response to the termination signal, terminating the stationary mode of the balancing transporter.

8. The method of claim 4, further comprising:
if the stationary mode is activated, receiving a termination signal; and
in response to the termination signal, terminating the stationary mode of the balancing transporter.

9. The method of claim 5, further comprising:
if the stationary mode is activated, receiving a termination signal; and
in response to the termination signal, terminating the stationary mode of the balancing transporter.

10. A device for controlling a balancing transporter, comprising:
a processor; and
a memory for storing instructions executable by the processor;
wherein the processor is configured to:
acquire distances between the balancing transporter and one or more obstacles around the balancing transporter;
determine a number of acquired distances that are shorter than a predetermined distance; and
when the number of the acquired distances shorter than the predetermined distance reaches a predetermined number, determine that a stationary mode of the balancing transporter needs to be activated, wherein the balancing transporter automatically maintains balance in the stationary mode.

11. The device of claim 10, wherein the processor is further configured to:
in response to the determination that the stationary mode needs to be activated, activate the stationary mode of the balancing transporter.

12. The device of claim 10, wherein the processor is further configured to:
prior to activating the stationary mode of the balancing transporter, receive a trigger signal that is transmitted from a surrounding device after the balancing transporter enters a predetermined area, the predetermined area being a communication area within which the surrounding device and the balancing transporter communicate with each other.

13. The device of claim 10, wherein the processor is further configured to:
present a prompt for activating the stationary mode of the balancing transporter;
detect whether a rejection signal is received within a predetermined time period, the rejection signal being configured to instruct the balancing transporter temporarily not to activate the stationary mode;
if the rejection signal is received within the predetermined time period, suspend the activation of the stationary mode; and
if no rejection signal is received within the predetermined time period, activate the stationary mode.

14. The device of claim 10, wherein the processor is further configured to activate the stationary mode of the balancing transporter by performing at least one of:
activating an auto-balancing system of the balancing transporter; or
activating a braking function of the balancing transporter.

15. The device of claim 11, wherein the processor is further configured to:
receive a termination signal; and
in response to the termination signal, terminate the stationary mode of the balancing transporter.

16. The device of claim 12, wherein the processor is further configured to:
if the stationary mode is activated, receive a termination signal; and
in response to the termination signal, terminate the stationary mode of the balancing transporter.

17. The device of claim 13, wherein the processor is further configured to:
if the stationary mode is activated, receive a termination signal; and
in response to the termination signal, terminate the stationary mode of the balancing transporter.

18. The device of claim 14, wherein the processor is further configured to:
if the stationary mode is activated, receive a termination signal; and
in response to the termination signal, terminate the stationary mode of the balancing transporter.

19. A non-transitory computer-readable storage medium storing instructions that, when executed by a processor of a device, cause the device to perform a method for controlling a balancing transporter, the method comprising:
acquiring distances between the balancing transporter and one or more obstacles around the balancing transporter;
determining a number of acquired distances that are shorter than a predetermined distance; and
when the number of the acquired distances shorter than the predetermined distance reaches a predetermined number, determining that a stationary mode of the balancing transporter needs to be activated, wherein the balancing transporter automatically maintains balance in the stationary mode.
